(19) United States
(12) Patent Application Publication
(10) Pub. No.: US 2026/0122708 A1
(43) Pub. Date: Apr. 30, 2026

(54) SYSTEM AND METHOD FOR DIRECT WIRELESS ROAMING

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 19/370,188

(22) Filed: Oct. 27, 2025

Related U.S. Application Data
(60) Provisional application No. 63/712,524, filed on Oct. 27, 2024.
(60) Provisional application No. 63/728,213, filed on Dec. 5, 2024.

(51) Int. Cl. H04W 76/15; H04W 8/02

(52) U.S. Cl. CPC H04W 76/15; H04W 8/02

(57) ABSTRACT

Embodiments of a method and apparatus for wireless communications are disclosed. In an embodiment, a wireless device includes a controller configured to identify a target access point (AP) multi-link device (MLD) and a wireless transceiver configured to establish links with the target AP MLD directly for wireless roaming of the wireless device from a current serving AP MLD to the target AP MLD.

### CROSS-REFERENCE TO RELATED APPLICATIONS

This application is entitled to the benefit of U.S. Provisional Patent Application Ser. No. 63/712,524, filed on Oct. 27, 2024 and U.S. Provisional Patent Application Ser. No. 63/728,213, filed on Dec. 5, 2024, the contents of each of which are incorporated by reference herein in their entireties.

### SUMMARY

Embodiments of a method and apparatus for wireless communications are disclosed. In an embodiment, a wireless device includes a controller configured to identify a target access point (AP) multi-link device (MLD) and a wireless transceiver configured to establish links with the target AP MLD directly for wireless roaming of the wireless device from a current serving AP MLD to the target AP MLD. Other embodiments are also disclosed.

In an embodiment, the wireless device includes a non-AP MLD with at least one affiliated non-AP station (STA).

In an embodiment, the controller is further configured to generate an initiating action frame directly addressed to the target AP MLD, and the wireless transceiver is further configured to transmit the initiating action frame to the target AP MLD for the wireless roaming of the non-AP MLD from the current serving AP MLD to the target AP MLD.

In an embodiment, the initiating action frame includes a link reconfiguration request.

In an embodiment, the initiating action frame includes a Media Access Control (MAC) header that includes an identifier of the current serving AP MLD and an identifier of the non-AP MLD, and a frame body that includes an identifier of the target AP MLD.

In an embodiment, the identifier of the current serving AP MLD includes a Basic Service Set (BSS) color of an AP affiliated with the current serving AP MLD.

In an embodiment, the identifier of the target AP MLD includes a Basic Service Set Identifier (BSSID) of the target AP MLD.

In an embodiment, the frame body further includes a Basic Service Set Identifier (BSSID) of the current serving AP MLD.

In an embodiment, the wireless transceiver is further configured to confirm a roaming intention of the non-AP MLD by transmitting a protected response action frame to the current serving AP MLD, and the current serving AP MLD transfers a security frame exchange context of the non-AP MLD to the target AP MLD.

In an embodiment, a Distribution System (DS) mapping of the non-AP MLD is initiated by the target AP MLD once the target AP MLD acquires the security frame exchange context.

In an embodiment, the non-AP MLD is notified of the target AP MLD's readiness for frame exchanges with the non-AP MLD.

In an embodiment, the current serving AP MLD transfers a security frame exchange context of the non-AP MLD to the target AP MLD when the non-AP MLD does not confirm a roaming intention.

In an embodiment, the wireless device is compatible with an Institute of Electrical and Electronics Engineers (IEEE) 802.11 protocol.

In an embodiment, a non-AP station (STA) multi-link device (MLD) includes a wireless transceiver configured to establish wireless links with a target access point (AP) multi-link device (MLD) directly and a controller configured to conduct wireless roaming of the non-AP MLD from a current serving AP MLD to the target AP MLD for frame exchanges through the links with the target AP MLD, the non-AP MLD is compatible with an Institute of Electrical and Electronics Engineers (IEEE) 802.11 protocol.

In an embodiment, a method for wireless communications includes at a wireless device, identifying a target access point (AP) multi-link device (MLD) and at the wireless device, establishing links with the target AP MLD directly for wireless roaming of the wireless device from a current serving AP MLD to the target AP MLD.

In an embodiment, the wireless device includes a non-AP MLD with at least one affiliated non-AP station (STA).

In an embodiment, the method further includes at the wireless device, generating an initiating action frame directly addressed to the target AP MLD and from the wireless device, transmitting the initiating action frame to the target AP MLD for the wireless roaming of the non-AP MLD from the current serving AP MLD to the target AP MLD.

In an embodiment, the initiating action frame includes a link reconfiguration request.

In an embodiment, the initiating action frame includes a Media Access Control (MAC) header that includes an identifier of the current serving AP MLD and an identifier of the non-AP MLD and a frame body that includes an identifier of the target AP MLD.

In an embodiment, the identifier of the current serving AP MLD includes a Basic Service Set (BSS) color of an AP affiliated with the current serving AP MLD.

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with example embodiments.

FIG. 2 depicts a multi-link (ML) communications system that is used for wireless communications in accordance with example embodiments.

FIG. 3 depicts a wireless device in accordance with example embodiments.

FIG. 4 illustrates a seamless roaming operation of a non-AP (STA) MLD in accordance with example embodiments.

FIG. 5 illustrates a frame format in accordance with example embodiments.

FIG. 6 illustrates a Peer AP MLD ID element in accordance with example embodiments.

FIG. 7 shows a swim-lane diagram illustrating an example wireless roaming procedure of a non-AP MLD from a current serving AP MLD of a Seamless Mobility Domain (SMD) to a target AP MLD of the SMD.

FIG. 8 shows a swim-lane diagram illustrating an example wireless roaming procedure of a non-AP MLD from a current serving AP MLD of an SMD to a target AP MLD of the SMD.

FIG. 9 is a process flow diagram of a method for wireless communications in accordance with example embodiments.

Throughout the description, similar reference numbers may be used to identify similar elements.

### DETAILED DESCRIPTION

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. A wireless device can roam within a wireless communications system in a roaming operation, such as, a seamless roaming operation. To facilitate the proper data transmission within a wireless communications system, there is a need for wireless roaming technology that can efficiently and securely convey wireless roaming information, for example, information related to data, communications links, and/or wireless devices (e.g., operation and/or capability parameters of wireless devices) within the wireless communications system.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

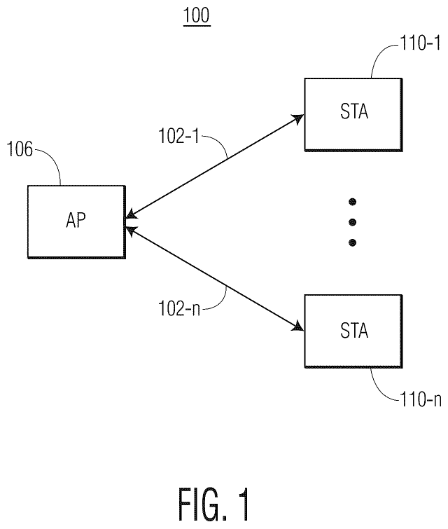

FIG. 1 depicts a wireless (e.g., WiFi) communications system 100 in accordance with example embodiments. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

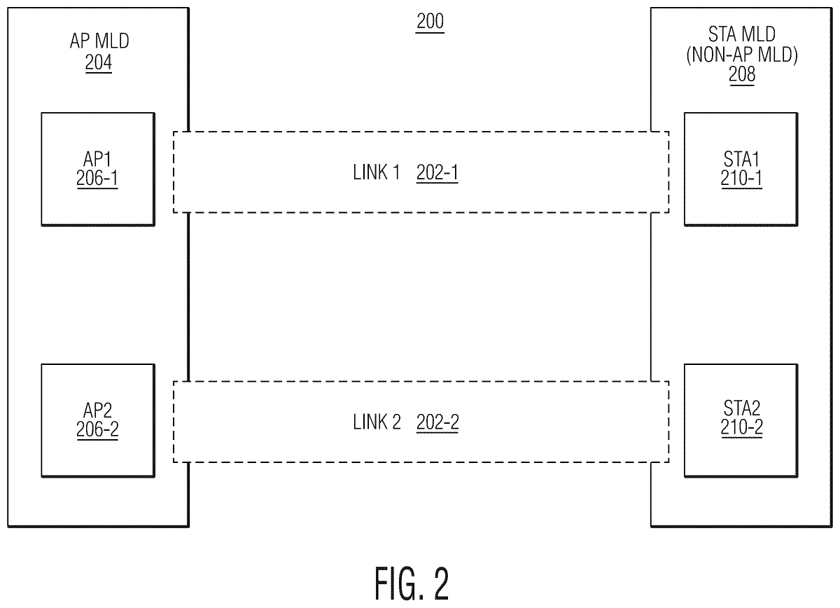

FIG. 2 depicts a multi-link (ML) communications system 200 that is used for wireless (e.g., WiFi) communications in accordance with example embodiments. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities common to all APs affiliated with the AP MLD 204 (e.g., association establishment, reordering of frames, etc.) and a link specific part of the AP MLD 204, i.e., the APs 206-1 and 206-2, implement upper layer MAC specific to a link and lower layer MAC functionalities (e.g., beaconing, backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re) Association Request frame, a (Re) Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

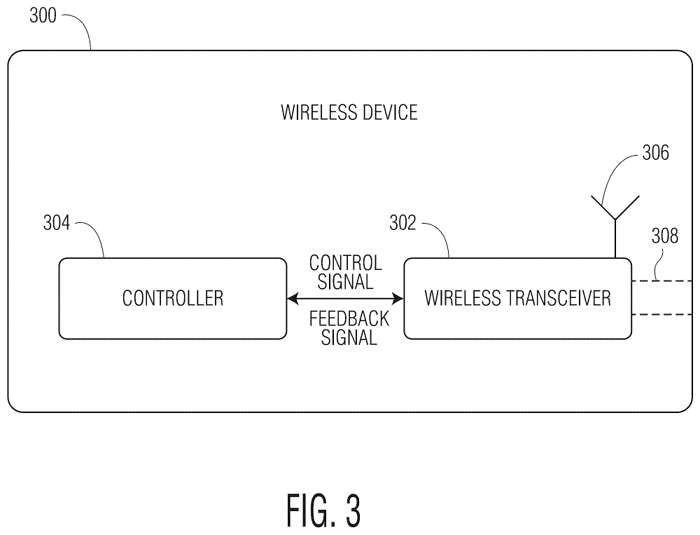

FIG. 3 depicts a wireless device 300 in accordance with example embodiments. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with example embodiments, the controller 304 is configured to identify a target access point (AP) multi-link device (MLD), and the wireless transceiver 302 is configured to establish links (e.g., wireless links) with the target AP MLD directly for wireless roaming of the wireless device from a current serving AP MLD to the target AP MLD, for example, through the at least one antenna 306. In some embodiments, the wireless transceiver 302 is configured to establish links (e.g., wireless links) with the target AP MLD without utilizing or requesting the current serving AP MLD to establish links (e.g., wireless links) with the target AP MLD on behalf of the wireless device 300. In some embodiments, the wireless device 300 includes a non-AP MLD with at least one affiliated non-AP station (STA). In some embodiments, the controller 304 is further configured to generate an initiating action frame directly addressed to the target AP MLD (e.g., without being addressed to the current serving AP MLD and utilizing or requesting the current serving AP MLD to relay the initiating action frame to the target AP MLD on behalf of the wireless device 300), and the wireless transceiver 302 is further configured to transmit the initiating action frame to the target AP MLD, for example, through the at least one antenna 306, for the wireless roaming of the non-AP MLD from the current serving AP MLD to the target AP MLD. In some embodiments, the initiating action frame includes a link reconfiguration request. In some embodiments, the initiating action frame addressed to the target AP MLD includes a Media Access Control (MAC) header that includes an identifier of the current serving AP MLD and an identifier of the non-AP MLD and a frame body that includes an identifier of the target AP MLD that is protected by a Pairwise Transient Key (PTK). In some embodiments, the identifier of the current serving AP MLD includes a BSS color of an AP affiliated with the current serving AP MLD. In some embodiments, the identifier of the target AP MLD includes a Basic Service Set Identifier (BSSID) of the target AP MLD. In some embodiments, the frame body further includes a Basic Service Set Identifier (BSSID) of the current serving AP MLD that is protected by the PTK.

In some embodiments, the wireless transceiver 302 is further configured to confirm a roaming intention of the non-AP MLD by verifying the non-AP MLD's intention with the current serving AP MLD through a secure path, for example, through the at least one antenna 306, and the current serving AP MLD transfers a security frame exchange context of the non-AP MLD to the target AP MLD. In some embodiments, a Distribution System (DS) mapping change of the non-AP MLD is initiated by the target AP MLD once the target AP MLD confirms the non-AP MLD's roaming intention and/or acquires the security frame exchange context. In some embodiments, the non-AP MLD is notified of the target AP MLD's readiness for frame exchanges with the non-AP MLD.

In some embodiments, the current serving AP MLD transfers a security frame exchange context of the non-AP MLD to the target AP MLD when the non-AP MLD does not confirm a roaming intention.

In some embodiments, the wireless device 300 is compatible with an Institute of Electrical and Electronics Engineers (IEEE) 802.11 protocol.

In some embodiments, a non-AP STA MLD includes a wireless transceiver configured to establish wireless links with a target access point (AP) multi-link device (MLD) directly (e.g., without utilizing or requesting the current serving AP MLD to establish wireless links with the target AP MLD on behalf of the non-AP STA MLD) and a controller configured to conduct wireless roaming of the non-AP MLD (for example, taking part in the operation or management of wireless roaming, such as to participate in frame exchanges (e.g., to transmit and receive frames)) from a current serving AP MLD to the target AP MLD for frame exchanges through the links with the target AP MLD, where the non-AP MLD is compatible with an Institute of Electrical and Electronics Engineers (IEEE) 802.11 protocol.

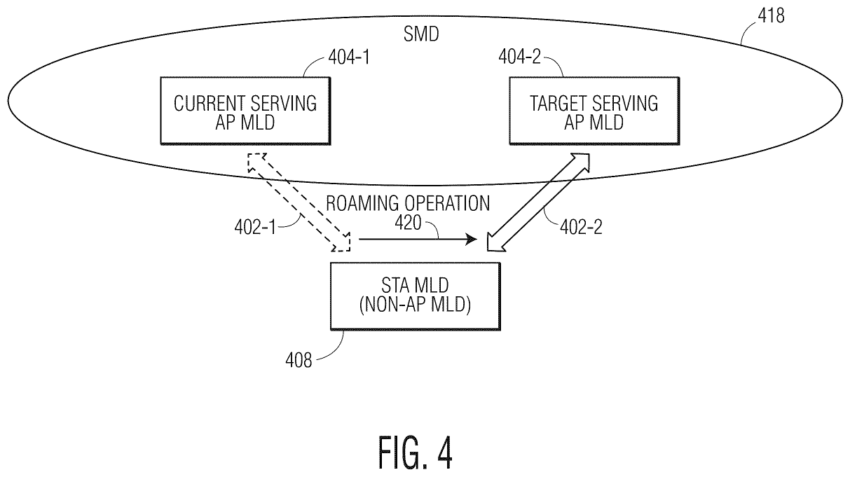

FIG. 4 illustrates a seamless roaming operation 420 of a non-AP (STA) MLD 408 in accordance with example embodiments. In the seamless roaming operation 420 illustrated in FIG. 4, the non-AP (STA) MLD 408 roams from a current serving AP MLD 404-1 of an SMD 418 to a target AP MLD 404-2 of the SMD 418. The SMD 418 may include multiple wireless devices with which the non-AP MLD 408 can establish wireless links and conduct frame exchanges. In some embodiments, the SMD 418 includes the current serving AP MLD 404-1 that currently maintains wireless links with the non-AP MLD 408 to perform the data frame exchanges and the target AP MLD 404-2 with which the non-AP MLD 408 establishes wireless links and conducts frame exchanges after the seamless roaming operation 420. Specifically, before the seamless roaming operation 420, the non-AP MLD 408 has established links 402-1 with the current serving AP MLD 404-1 and conducts frame exchanges with the current serving AP MLD 404-1. During the seamless roaming operation 420, the non-AP (STA) MLD 408 establishes links 402-2 with the target serving AP MLD 404-2. In some embodiments, within a temporary duration after the seamless roaming, the non-AP MLD may receive the downlink (DL) data frames from both the current serving AP MLD 404-1 and the target AP MLD 404-2 while transmitting the uplink (UL) data frames to the target AP MLD 404-2 only. In some embodiments, after the temporary duration, the STA MLD 408 stops the frame exchanges with the current serving AP MLD 404-1, and executes the frame exchanges with the target serving AP MLD 404-2.

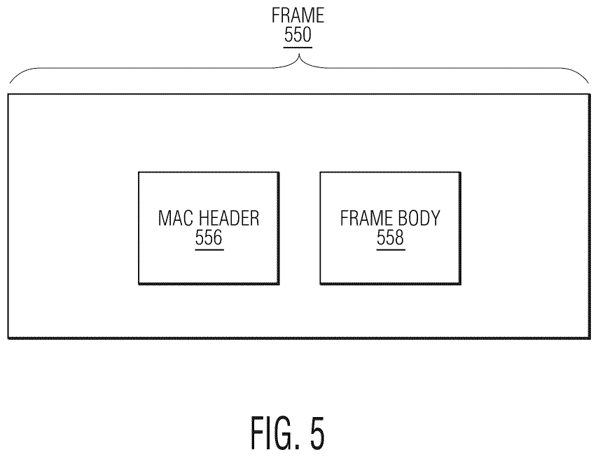

FIG. 5 illustrates a frame format 550 in accordance with example embodiments. The frame format 550 illustrated in FIG. 5 can be used for communications by the wireless communications system 100 depicted in FIG. 1, by a STA/AP affiliated with the multi-link (ML) communications system 200 depicted in FIG. 2, the wireless device 300 depicted in FIG. 3, and/or the current serving AP MLD 404-1, the non-AP (STA) MLD 408, and/or the target serving AP MLD 404-2. In the embodiment depicted in FIG. 5, the frame format 550 include a Media Access Control (MAC) header 556 and a frame body 558. In some embodiments, the frame format 550 is an initiating action frame, which may be a link reconfiguration request. In some embodiments, the MAC header 556 includes an identifier of a current serving AP MLD and an identifier of a non-AP MLD, and the frame body 558 includes an identifier of a target AP MLD. In some embodiments, the identifier of the current serving AP MLD includes an identifier of the current serving AP MLD (e.g., BSS color of an AP affiliated with the current serving AP MLD). In some embodiments, the identifier of the target AP MLD includes a Basic Service Set Identifier (BSSID) of the current serving AP MLD. In some embodiments, the identifier of the non-AP MLD includes the association identifier (AID) of the non-AP MLD.

In some implementations, in a roaming procedure through a serving AP MLD, an optional step 1 involves candidate target serving AP MLD recommendation. For example, a non-AP MLD acquires the candidate target serving AP MLDs through its current serving AP MLD. Step 2 involves establishing the links with the target serving AP MLD through the current serving AP MLD. Step 3 involves roaming from the current serving AP MLD to the target AP MLD, for example, DS mapping update with an access server, a router, or an ethernet switch, frame exchange context transfer to the target AP MLD. The uplink (UL) frame changes for UL Data frames are suspended during step 3. Step 4 involves stopping the frame exchanges of Data frames with the current serving AP MLD and executing the frame exchanges of Data frames with the target serving AP MLD. It is possible that both the current serving AP MLD and the target serving AP MLD transmit downlink (DL) Data frames for some time (grace period) at step 4 before the following: stopping the frame exchanges of Data frames with the current serving AP MLD, and executing the frame exchanges of Data frames with the target serving AP MLD. The UL Data frames can only be transmitted to the target AP MLD.

In some embodiments, the seamless roaming is done directly with a target AP MLD. In some embodiments, an Action frame from the STA MLD for roaming is exchanged with the target roaming AP MLD directly (e.g., without utilizing or requesting a current serving AP MLD to relay messages to and from the target AP MLD on behalf of the STA MLD). In some embodiments, the identification of a serving AP MLD and a non-AP MLD in a MAC header of a protected Action frame is directly sent to the roaming AP MLD before the security context of the non-AP MLD being transferred to the target AP MLD. In some embodiments, the target AP MLD and the current serving AP MLD verify whether the non-AP MLD intend to do or conduct the roaming before transferring the non-AP MLD's frame exchange context to the target AP MLD and changing the DS mapping of the non-AP MLD.

Some implementations of a roaming procedure directly with a target AP MLD (e.g., without utilizing or requesting a current serving AP MLD to conduct a roaming procedure with the target AP MLD on behalf of a STA MLD), for example, by the wireless communications system 100 depicted in FIG. 1, the multi-link (ML) communications system 200 depicted in FIG. 2, the wireless device 300 depicted in FIG. 3, and/or the current serving AP MLD 404-1, the target AP MLD 404-2, and/or the non-AP (STA) MLD 408 depicted in FIG. 4 are described.

In some embodiments, in Option 1, security context transfer (e.g., Pairwise Master Key (PMK), Pairwise Transient Key (PTK), minimal unallocated Packet Number (PN) number, replay counters per Traffic Identifier (TID) of Data frames, replay counter of protected Action frame) is from a serving AP MLD to a target AP MLD. In some embodiments, the Action frame directly to the target AP MLD carries, in a High Efficiency (HE) Control field, the current serving AP MLD identifier and a non-AP MLD identifier, whether the non-AP MLD is still available through the current serving AP MLD, and/or in a protected frame body, the target AP MLD identifier that the non-AP MLD intends to roam to. In some embodiments, the current serving AP MLD checks the non-AP MLD's roaming intention and the target AP MLD per the target AP MLD's notification if the non-AP MLD intending to roaming is still reachable. Otherwise, the non-AP MLD's roaming intention is checked per the frame body of the non-AP MLD's Action frame, e.g. whether the non-AP MLD's Action frame can be decrypted correctly.

In some embodiments, in Option 2, the new PTK negotiation is directly with the target AP MLD (e.g., without utilizing or requesting a current serving AP MLD to negotiate a new PTK agreement with the target AP MLD on behalf of a STA MLD). In some embodiments, the frame for PTK renewal is directly sent to the target AP MLD. In some embodiments, the PMK is transferred from the current serving AP MLD to the target AP MLD. In some embodiments, the successful PTK renewal verifies the non-AP MLD's roaming intention.

Some implementations of a frame exchange context, for example, by the wireless communications system 100 depicted in FIG. 1, the multi-link (ML) communications system 200 depicted in FIG. 2, the wireless device 300 depicted in FIG. 3, and/or the current serving AP MLD 404-1, the target AP MLD 404-2, and/or the non-AP (STA) MLD 408 depicted in FIG. 4 are described.

In some embodiments, for a data frame exchange context, in Option 1, the frame exchange context related to data frames with/without block acknowledgement (BA) agreement(s) is not transferred to a target AP MLD in which case the new sequence number (SN) space starting from 0 for each TID is used with the target AP MLD. In some embodiments, in Option 2, the frame exchange context related to data frames with/without BA agreement(s) are transferred to the target AP MLD.

In some embodiments, for security context, in Option 1, the frame exchange context related to security, for example, PTK, PN, replay counters, are transferred to the target AP MLD if the rekeying is not done/conducted during the roaming stage. Otherwise, the frame exchange context related to security is transferred to the target AP MLD. In some embodiments, in Option 2, the frame exchange context related to security, for example, PTK, PN, replay counters, are always transferred to the target AP MLD.

In some embodiments, for Emergency Preparedness Communication Service (EPCS) context, in Option 1, the context related to an outside server, e.g., EPCS enabling, EPCS authentication information, is transferred to the target AP MLD.

Some implementations of a roaming procedure directly with a target AP MLD, for example, by the wireless communications system 100 depicted in FIG. 1, the multi-link (ML) communications system 200 depicted in FIG. 2, the wireless device 300 depicted in FIG. 3, and/or the current serving AP MLD 404-1, the target AP MLD 404-2, and/or the non-AP (STA) MLD 408 depicted in FIG. 4 are described.

In some embodiments, an optional step 1 involves a candidate target serving AP MLD recommendation. In some embodiments, a non-AP MLD acquires the candidate target serving AP MLDs through its current serving AP MLD.

In some embodiments, in Step 2, the non-AP MLD establishes links (e.g., wireless links) with a target serving AP MLD directly (e.g., without utilizing or requesting a current serving AP MLD to establish links (e.g., wireless links) with the target AP MLD on behalf of the non-AP MLD). In another option, the link establishment is done/conducted after verifying that the non-AP MLD intends to roam to the target AP MLD.

In some embodiments, in step 3, after verifying that the non-AP MLD intends to roam to the target AP MLD, the target AP MLD acquires the frame exchange context and triggers the DS mapping change.

In some embodiments, in step 4, the non-AP MLD starts the downlink (DL)/uplink (UL) frame exchanges with the target AP MLD after the frame exchange context is transferred to the target AP MLD and DS mapping is changed.

Some implementations of identifications of peer AP MLD and optional addressed AP MLD, for example, by the wireless communications system 100 depicted in FIG. 1, the multi-link (ML) communications system 200 depicted in FIG. 2, the wireless device 300 depicted in FIG. 3, and/or the current serving AP MLD 404-1, the target AP MLD 404-2, and/or the non-AP (STA) MLD 408 depicted in FIG. 4 are described.

In some embodiments, a non-AP MLD may start the seamless roaming with a target AP MLD directly since the link with a current serving AP MLD is not available, e.g., using an ML Reconfiguration Request and/or a Roaming Request addressed to the target AP MLD. In such case, the ML Reconfiguration Request carries the identifier of the current serving AP MLD, e.g., by carrying a Peer AP MLD ID element in the frame body, the BSS color of one AP affiliated with the current serving AP MLD in MAC header's HE Control field of the ML Reconfiguration Request. In some embodiments, the Peer AP MLD ID element carries the identifier of the peer AP MLD (the current serving AP MLD in this case) and optional the MAC address of the addressed AP MLD (target AP MLD in this case). In some embodiments, the AP MLD MAC address is used as the identifier.

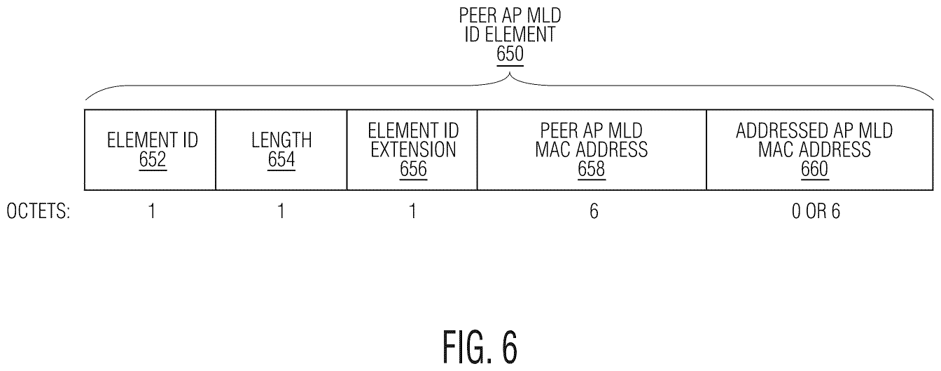

FIG. 6 illustrates a Peer AP MLD ID element 660 in accordance with example embodiments. The Peer AP MLD ID element 660 illustrated in FIG. 6 can be used for communications by the wireless communications system 100 depicted in FIG. 1, the multi-link (ML) communications system 200 depicted in FIG. 2, the wireless device 300 depicted in FIG. 3, and/or the current serving AP MLD 404-1, the target AP MLD 404-2, and/or the non-AP (STA) MLD 408 depicted in FIG. 4. In the embodiment depicted in FIG. 6, the Peer AP MLD ID element 650 include an element identification (ID) field 652 (e.g., one-octet) that may contain element ID information, a length field 654 (e.g., one-octet) that may contain length information, an Element ID extension field 656 (e.g., one-octet) that may contain Element ID extension information, a Peer AP MLD MAC Address field 658 (e.g., six-octet) that may contain Peer AP MLD MAC Address information, and an addressed AP MLD MAC Address field 660 (e.g., zero or six-octet) that may contain addressed AP MLD MAC Address information.

Some implementations of a protected initiating action frame in a roaming procedure directly with a target AP MLD, for example, by the wireless communications system 100 depicted in FIG. 1, the multi-link (ML) communications system 200 depicted in FIG. 2, the wireless device 300 depicted in FIG. 3, and/or the current serving AP MLD 404-1, the target AP MLD 404-2, and/or the non-AP (STA) MLD 408 depicted in FIG. 4 are described.

In some embodiments, a protected initiating action frame (e.g., a new defined action frame or an updated multi-link reconfiguration request) transmitted by a non-AP MLD and directly addressed to a target AP MLD carries the following information:
the following subfields in a new defined HE control field, which includes the non-AP MLD's identifier, e.g., an AID11 subfield, for example, the non-AP MLD's AID allocated by a serving AP MLD, the identifier of the non-AP MLD's serving AP MLD, e.g., 6-bit BSS color of one AP affiliated with AP MLD ID subfield (the BSS color of one AP affiliated with the current serving AP MLD is announced by the current serving AP MLD), and whether or not the non-AP MLD is still available through the current serving AP MLD, e.g., one-bit subfield (One variant is that the non-AP MLD can initiate the roaming through the target AP MLD only when the non-AP MLD cannot reach the current serving AP MLD); and
the following elements being protected in the frame body (e.g., the Peer AP MLD ID element). In some embodiments, the addressed AP MLD MAC address being carried in the protected frame body can avoid a third party (3^{rd}-party) STA's attack. In some embodiments, a non-AP MLD intends to roam to a target AP MLD (MLD2) from a serving AP MLD (MLD1) by transmitting an initiating action frame to the AP MLD2, a 3^{rd}-party STA detects the non-AP MLD's frame and interferes the AP MLD2's reception of the initiating action frame to the AP MLD2, the 3^{rd}-party STA transmits the initiating action frame to the AP MLD3, and the AP MLD3 checks the decrypted frame body and figures out the attack because the frame body indicates the AP MLD2 as the target AP MLD.

In some embodiments, in a first case, the initiating action frame indicates that the non-AP MLD is still available to the current serving AP MLD. In some embodiments, the target AP MLD verifies the non-AP MLD's intention of roaming through the current serving AP MLD. In some embodiments, the current serving AP MLD is identified per the new defined HE Control field in the initiating action frame. In some embodiments, the protected action frame is not forwarded to the current serving AP MLD.

In some embodiments, the correct decryption of the Action frame from the non-AP MLD by the non-AP MLD's PTK stored in the current AP MLD and the decrypted frame body's indication of the non-AP MLD's roaming request to the target MLD confirms the intention of the non-AP MLD's roaming request. In some embodiments, the current serving AP MLD checks the non-AP MLD's intention of the roaming to the target AP MLD through transmitting a protected request action frame to the non-AP MLD.

In some embodiments, if/when the non-AP MLD's intention of roaming is confirmed, e.g., through transmitting a protected response action frame to the current serving AP MLD and confirming the non-AP MLD's roaming intention by using the decrypted frame body or the other confirmation method, the current serving AP MLD transfers the frame exchange context of the non-AP MLD to the target AP MLD. In some embodiments, the target AP MLD transmits the protected response to the initiating action frame to accept the roaming request. In some embodiments, the non-AP MLD establish the links (e.g., wireless links) with the target AP MLD through the other frame if the initiating action frame is not a multi-link reconfiguration request frame. In some embodiments, the target AP MLD initiates the DS mapping change. In some embodiments, after the DS mapping change, the target AP MLD sends the protected responding frame to the non-AP MLD to confirm the target AP MLD becomes the current serving AP MLD of the non-AP MLD.

In some embodiments, if/when the non-AP MLD rejects the roaming through the protected response Action frame solicited by the current serving AP MLD, the current serving AP MLD notifies the target AP MLD such rejection. In some embodiments, the target AP MLD records an attack.

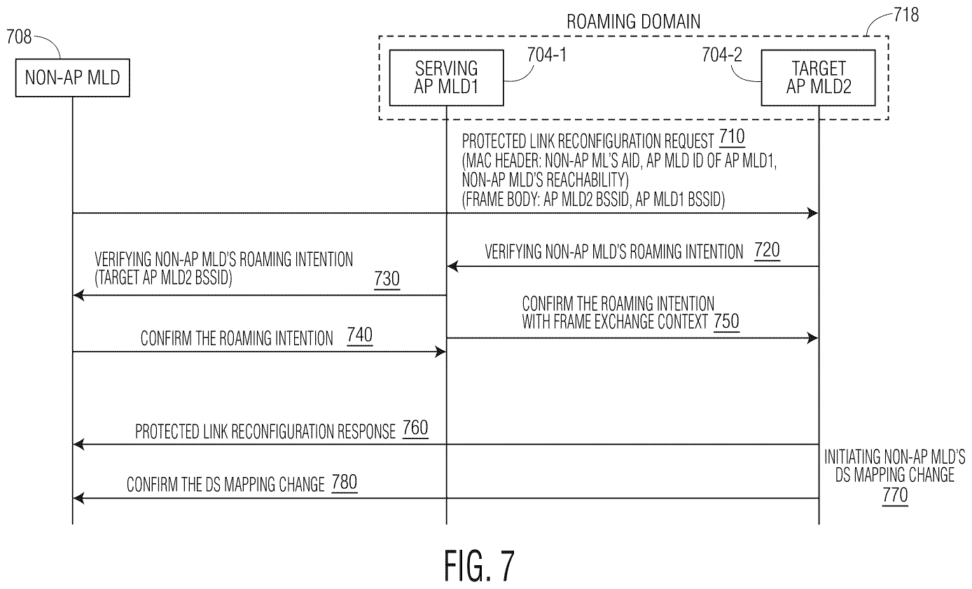

FIG. 7 shows a swim-lane diagram illustrating an example wireless roaming procedure of a non-AP MLD 708 from a current serving AP MLD 704-1 of an SMD 718 to a target AP MLD 704-2 of the SMD 718. In the wireless roaming procedure depicted in FIG. 7, the non-AP MLD 708 may be similar to, the same as, or a component of the non-AP MLD 208 depicted in FIG. 2 and/or the non-AP MLD 408 depicted in FIG. 4, the current serving AP MLD 704-1 may be similar to, the same as, or a component of the AP MLD 204 depicted in FIG. 2 and/or the current serving AP MLD 404-1 depicted in FIG. 4, and the target AP MLD 704-2 may be similar to, the same as, or a component of the AP MLD 204 depicted in FIG. 2 and/or the target AP MLD 404-2 depicted in FIG. 4. Although operations in the example procedure in FIG. 7 are described in a particular order, in some embodiments, the order of the operations in the example procedure may be altered so that certain operations may be performed in an inverse order or so that certain operations may be performed, at least in part, concurrently with other operations.

In the swim-lane diagram depicted in FIG. 7, the non-AP MLD 708 sends a protected multi-link reconfiguration request, for example, with a MAC header: the non-AP MLD's AID, BSS color of an AP affiliated with AP MLD1, the Non-AP MLD's reachability, receiver address (RA) to identify the AP affiliated with the target AP MLD, transmitter address (TA) to identify the STA of the non-AP MLD, and/or with a frame body: AP MLD2 BSSID, AP MLD1 BSSID to the target AP MLD 704-2 in step 710. The target AP MLD 704-2 sends a message for verifying the non-AP MLD's roaming intention to the current serving AP MLD 704-1 in step 720. The current serving AP MLD 704-1 decrypted the message to verify whether the roaming request is sent by the non-AP MLD. Another variant is that the target AP MLD acquire the PTK of the non-AP MLD from the current serving AP MLD 704-1 to decrypt the received multi-link reconfiguration request. The current serving AP MLD 704-1 may further send a message for verifying non-AP MLD's roaming intention with the target AP MLD2's BSSID to the non-AP MLD 708 in step 730.

The non-AP MLD 708 sends a message for confirming the roaming intention to the current serving AP MLD 704-1 in step 740. The current serving AP MLD 704-1 sends a message for confirming the roaming intention with a frame exchange context to the target AP MLD 704-2 in step 750.

The target AP MLD 704-2 sends a protected multi-link reconfiguration response to the non-AP MLD 708 in step 760. In step 770, the target AP MLD 704-2 initiates non-AP MLD's DS mapping change. The target AP MLD 704-2 sends a message for confirming the DS mapping change to the non-AP MLD 708 in step 780.

In some embodiments, in a second case, the initiating action indicates that the non-AP MLD is not available to the current serving AP MLD. In some embodiments, the target AP MLD requests the non-AP MLD's security context from the current serving AP MLD if the non-AP MLD is not available by the current serving AP MLD. In some embodiments, the current serving AP MLD is indicated or identified per the new defined HE Control field in the Initiating Action frame. In some embodiments, in a variant, the target AP MLD also sends the protected initiating action frame to the current serving AP MLD.

In some embodiments, the current serving AP MLD checks with the non-AP MLD whether the non-AP MLD is not available. In some embodiments, if/when the non-AP MLD is available and confirms the roaming, the first case is followed. In some embodiments, if/when the check's result is true, the current serving AP MLD transfers the security context to the target AP MLD. In some embodiments, the target AP MLD decrypts the initiating action frame and verifies whether the non-AP MLD intends the roaming to the target AP MLD. In some embodiments, the Peer AP MLD ID element is used for the verification. In some embodiments, if/when the verification is successful, the target AP MLD transmits the response to the initiating Action frame to accept the roaming request, and the target AP MLD acquires the non-AP MLD's other frame exchange context from the current serving AP MLD and initiates the DS mapping change. In some embodiments, after the DS mapping change, the target AP MLD sends the protected responding frame to the non-AP MLD to confirm the target AP MLD becomes the current serving AP MLD of the non-AP MLD. In some embodiments, if/when the verification is not successful, the target AP MLD records an attack.

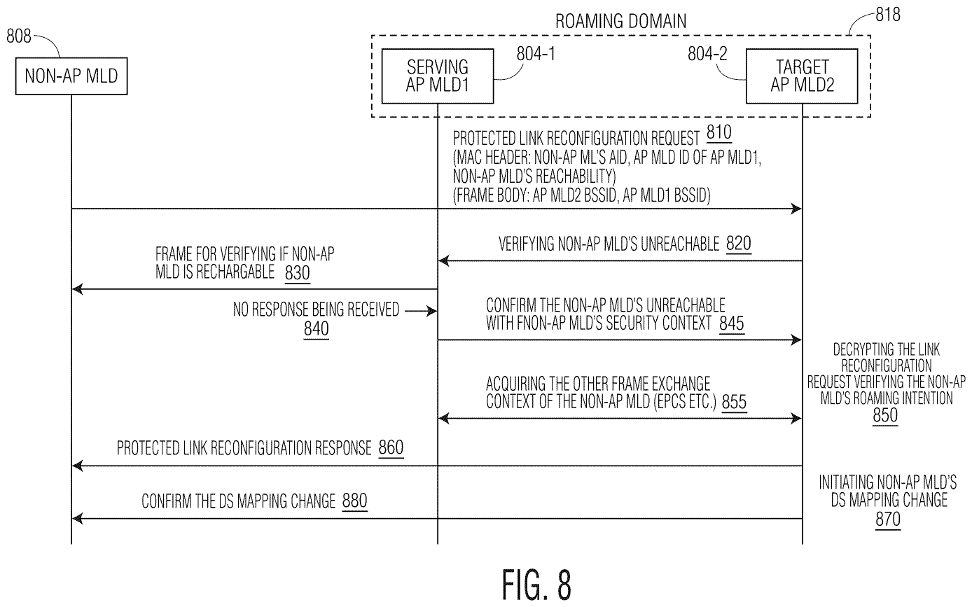

FIG. 8 shows a swim-lane diagram illustrating an example wireless roaming procedure of a non-AP MLD 808 from a current serving AP MLD 804-1 of an SMD 818 to a target AP MLD 804-2 of the SMD 818. In the wireless roaming procedure depicted in FIG. 8, the non-AP MLD 808 may be similar to, the same as, or a component of the non-AP MLD 208 depicted in FIG. 2 and/or the non-AP MLD 408 depicted in FIG. 4, the current serving AP MLD 804-1 may be similar to, the same as, or a component of the AP MLD 204 depicted in FIG. 2 and/or the current serving AP MLD 404-1 depicted in FIG. 4, and the target AP MLD 804-2 may be similar to, the same as, or a component of the AP MLD 204 depicted in FIG. 2 and/or the target AP MLD 404-2 depicted in FIG. 4. Although operations in the example procedure in FIG. 8 are described in a particular order, in some embodiments, the order of the operations in the example procedure may be altered so that certain operations may be performed in an inverse order or so that certain operations may be performed, at least in part, concurrently with other operations.

In the swim-lane diagram depicted in FIG. 8, the non-AP MLD 808 sends a protected multi-link reconfiguration request, for example, with a MAC header that includes non-AP MLD's AID, BSS color of the AP affiliated with AP MLD1, Non-AP MLD's reachability and/or with a frame body that includes AP MLD2 BSSID, AP MLD1 BSSID to the target AP MLD 804-2 in step 810. The target AP MLD 804-2 sends a message for verifying the non-AP MLD's roaming intention to the current serving AP MLD 804-1 in step 820. The current serving AP MLD 804-1 sends a message for verifying non-AP MLD's roaming intention with the target AP MLD2's BSSID to the non-AP MLD 808 in step 830.

In step 840, the current serving AP MLD 804-1 does not receive a response from the non-AP MLD 808 after, for example, a predetermined time period. The current serving AP MLD 804-1 sends a message for confirming that the non-AP MLD is unreachable with the non-AP MLD's security context to the target AP MLD 804-2 in step 845. In step 850, the target AP MLD 804-2 decrypts the link reconfiguration request, verifying the non-AP MLD's roaming intention. In step 855, the current serving AP MLD 804-1 and the target AP MLD 804-2 acquire the other frame exchange context (EPCS etc.,) of the non-AP MLD 808.

The target AP MLD 804-2 sends a protected multi-link reconfiguration response to the non-AP MLD 808 in step 860. In step 870, the target AP MLD 804-2 initiates non-AP MLD's DS mapping change. The target AP MLD 804-2 sends a message for confirming the DS mapping change to the non-AP MLD 808 in step 880.

Some implementations of rekeying with a target AP MLD in a roaming procedure directly with the target AP MLD, for example, by the wireless communications system 100 depicted in FIG. 1, the multi-link (ML) communications system 200 depicted in FIG. 2, the wireless device 300 depicted in FIG. 3, and/or the current serving AP MLD 404-1, the target AP MLD 404-2, and/or the non-AP (STA) MLD 408 depicted in FIG. 4 are described.

In some embodiments, seamless roaming is performed or conducted with negotiated new PTK. In some embodiments, before the roaming operation, a non-AP MLD negotiates the new PTK with a target AP MLD. In some embodiments, the key negotiation procedure is conducted by using a Pairwise Master Key (PMK). In some embodiments, the key negotiation procedure by using the PTK (PTK1) negotiated with the current serving AP MLD can be used, e.g., the non-AP MLD's request addressed to the target AP MLD is protected by the PTK (PTK1). In such method, the PTK is acquired from the current serving AP MLD. In some embodiments, in another variant, the key negotiation is done after the link adding. In some embodiments, SMD key derivation key (KDK) (e.g., with the same length as PMK that is derived when the non-AP MLD is associated with the SMD) is used to derive the non-AP MLD's PTK when the non-AP MLD roams to a target AP MLD through the seamless roaming procedure (e.g., the SMD transition procedure).

In some embodiments, the non-AP MLD establish the links (e.g., wireless links) with the target AP MLD after the success PTK negotiation.

In some embodiments, the Peer AP MLD ID element (e.g., with MLD MAC address of the current serving AP MLD or AP MLD ID of the current serving AP MLD announced by the target AP MLD) is carried in an Extensible Authentication Protocol over LAN (EAPOL)-Key frame or Action frame to identify a current serving AP MLD. In some embodiments, the target AP MLD acquires the PMK of the non-AP MLD from the current serving AP MLD.

In some embodiments, after the PTK is established with the non-AP MLD, the target AP MLD acquires the frame exchange context of the non-AP MLD through the current serving AP MLD. Subsequently, the target AP MLD initiates the change of the non-AP MLD's DS mapping.

In some embodiments, a method of conducting seamless roaming by second devices (e.g., non-AP MLD) with multiple link(s) seamlessly roaming between two first devices includes associating, by the second device, with the first device 1 (serving first device) that announces the enabling of seamless roaming where the first device 1 is the current serving AP MLD of the second device, and roaming, by the second device, to the target first device directly. In some embodiments, the second device sends an initiating Action frame with the identifier of the serving first device, the AID of the second device allocated by the serving first device in MAC header where the frame body of the initiating Action frame is protected by the security frame exchange context of second device in serving first device. In some embodiments, the serving first device transfers the second device's security frame exchange context to the target first device if the second device confirms its roaming decision. In some embodiments, the target first device verifies the correct decryption of the initiating Action frame, and the frame body carries its identifier that indicates the real target first device. In some embodiments, the target first device acquires the frame exchange context and initiates the DS mapping of the second device. In some embodiments, the target first device notifies the second device its the readiness of frame exchanges with the second device.

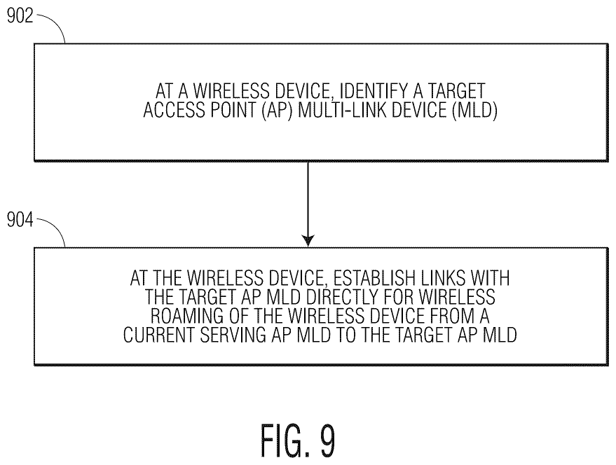

FIG. 9 is a process flow diagram of a method for wireless communications in accordance with example embodiments. At block 902, at a wireless device, a target access point (AP) multi-link device (MLD) is identified. At block 904, at the wireless device, links are establishing with the target AP MLD directly for wireless roaming of the wireless device from a current serving AP MLD to the target AP MLD. In some embodiments, the wireless device includes a non-AP MLD with at least one affiliated non-AP station (STA). In some embodiments, at the wireless device, an initiating action frame directly addressed to the target AP MLD is generated, and from the wireless device, the initiating action frame is transmitted to the target AP MLD for the wireless roaming of the non-AP MLD from the current serving AP MLD to the target AP MLD. In some embodiments, the initiating action frame includes a link reconfiguration request. In some embodiments, the initiating action frame includes a Media Access Control (MAC) header that includes an identifier of the current serving AP MLD and an identifier of the non-AP MLD and a frame body that includes an identifier of the target AP MLD. In some embodiments, the identifier of the current serving AP MLD includes a BSS color of an AP affiliated with the current serving AP MLD. In some embodiments, the identifier of the target AP MLD includes a Basic Service Set Identifier (BSSID) of the target AP MLD. In some embodiments, the frame body further includes a Basic Service Set Identifier (BSSID) of the current serving AP MLD. In some embodiments, a roaming intention of the non-AP MLD is confirmed by transmitting a protected response action frame to the current serving AP MLD, and the current serving AP MLD transfers a security frame exchange context of the non-AP MLD to the target AP MLD. In some embodiments, a Distribution System (DS) mapping of the non-AP MLD is initiated by the target AP MLD once the target AP MLD acquires the security frame exchange context. In some embodiments, the non-AP MLD is notified of the target AP MLD's readiness for frame exchanges with the non-AP MLD. In some embodiments, the current serving AP MLD transfers a security frame exchange context of the non-AP MLD to the target AP MLD when the non-AP MLD does not confirm a roaming intention. In some embodiments, the wireless device is compatible with an Institute of Electrical and Electronics Engineers (IEEE) 802.11 protocol. The wireless device may be the same as or similar to an embodiment of the STA 110-1, . . . , or 110-n depicted in FIG. 1, the STAs 210-1, 210-2 and/or the STA MLD 208 depicted in FIG. 2, the wireless device 300 depicted in FIG. 3, the STA MLD 408 depicted in FIG. 4, the STA MLD 708 depicted in FIG. 7, and/or the STA MLD 808 depicted in FIG. 8. The current serving AP MLD may be the same as or similar to an embodiment of the AP MLD 204 depicted in FIG. 2, the wireless device 300 depicted in FIG. 3, the current serving AP MLD 404-1 depicted in FIG. 4, the current serving AP MLD 704-1 depicted in FIG. 7, and/or the current serving AP MLD 804-1 depicted in FIG. 8. The target AP MLD may be the same as or similar to an embodiment of the AP MLD 204 depicted in FIG. 2, the wireless device 300 depicted in FIG. 3, the target AP MLD 404-2 depicted in FIG. 4, the target AP MLD 704-2 depicted in FIG. 7, and/or the target AP MLD 804-2 depicted in FIG. 8.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the disclosure may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the claims is to be defined by the claim language and their equivalents.

What is claimed is:

1. A wireless device comprising:
a controller configured to identify a target access point (AP) multi-link device (MLD); and
a wireless transceiver configured to establish a plurality of links with the target AP MLD directly for wireless roaming of the wireless device from a current serving AP MLD to the target AP MLD.

2. The wireless device of claim 1, wherein the wireless device comprises a non-AP MLD with at least one affiliated non-AP station (STA).

3. The wireless device of claim 2, wherein the controller is further configured to generate an initiating action frame directly addressed to the target AP MLD, and wherein the wireless transceiver is further configured to transmit the initiating action frame to the target AP MLD for the wireless roaming of the non-AP MLD from the current serving AP MLD to the target AP MLD.

4. The wireless device of claim 3, wherein the initiating action frame comprises a link reconfiguration request.

5. The wireless device of claim 3, wherein the initiating action frame comprises:
a Media Access Control (MAC) header that comprises an identifier of the current serving AP MLD and an identifier of the non-AP MLD; and
a frame body that comprises an identifier of the target AP MLD.

6. The wireless device of claim 5, wherein the identifier of the current serving AP MLD comprises a Basic Service Set (BSS) color of an AP affiliated with the current serving AP MLD.

7. The wireless device of claim 5, wherein the identifier of the target AP MLD comprises a Basic Service Set Identifier (BSSID) of the target AP MLD.

8. The wireless device of claim 7, wherein the frame body further comprises a Basic Service Set Identifier (BSSID) of the current serving AP MLD.

9. The wireless device of claim 2, wherein the wireless transceiver is further configured to confirm a roaming intention of the non-AP MLD by transmitting a protected response action frame to the current serving AP MLD, and wherein the current serving AP MLD transfers a security frame exchange context of the non-AP MLD to the target AP MLD.

10. The wireless device of claim 9, wherein a Distribution System (DS) mapping of the non-AP MLD is initiated by the target AP MLD once the target AP MLD acquires the security frame exchange context.

11. The wireless device of claim 2, wherein the non-AP MLD is notified of the target AP MLD's readiness for a plurality of frame exchanges with the non-AP MLD.

12. The wireless device of claim 2, wherein the current serving AP MLD transfers a security frame exchange context of the non-AP MLD to the target AP MLD when the non-AP MLD does not confirm a roaming intention.

13. The wireless device of claim 1, wherein the wireless device is compatible with an Institute of Electrical and Electronics Engineers (IEEE) 802.11 protocol.

14. A non-AP station (STA) multi-link device (MLD) comprising:
a wireless transceiver configured to establish a plurality of wireless links with a target access point (AP) multi-link device (MLD) directly; and
a controller configured to conduct wireless roaming of the non-AP MLD from a current serving AP MLD to the target AP MLD for a plurality of frame exchanges through the links with the target AP MLD,
wherein the non-AP MLD is compatible with an Institute of Electrical and Electronics Engineers (IEEE) 802.11 protocol.

15. A method for wireless communications, the method comprising:
at a wireless device, identifying a target access point (AP) multi-link device (MLD); and
at the wireless device, establishing a plurality of links with the target AP MLD directly for wireless roaming of the wireless device from a current serving AP MLD to the target AP MLD.

16. The method of claim 15, wherein the wireless device comprises a non-AP MLD with at least one affiliated non-AP station (STA).

17. The method of claim 16, further comprising:
at the wireless device, generating an initiating action frame directly addressed to the target AP MLD; and
from the wireless device, transmitting the initiating action frame to the target AP MLD for the wireless roaming of the non-AP MLD from the current serving AP MLD to the target AP MLD.

18. The method of claim 17, wherein the initiating action frame comprises a link reconfiguration request.

19. The method of claim 18, wherein the initiating action frame comprises:
a Media Access Control (MAC) header that comprises an identifier of the current serving AP MLD and an identifier of the non-AP MLD; and
a frame body that comprises an identifier of the target AP MLD.

20. The method of claim 19, wherein the identifier of the current serving AP MLD comprises a Basic Service Set (BSS) color of an AP affiliated with the current serving AP MLD.
